(19) United States
(12) Patent Application Publication
(10) Pub. No.: US 2004/0017056 A1
(43) Pub. Date: Jan. 29, 2004

(54) Twin-tube frame scooter

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/201,690

(22) Filed: Jul. 24, 2002

(51) Int. Cl. B62M 1/00

(52) U.S. Cl. 280/87.041

(57) ABSTRACT

A scooter with a twin-tube frame for improved riding safety includes a twin-tube frame comprised of two tubes in parallel having the front and the rear of each tube fixed with a fixation plate, and a board bolted onto the twin-tube frame; the middle section of each tube being inclined upward and incorporated to each other at their front sections and a hollow triangle area being defined by both tubes extending forward to meet each other; the board also extending at its front section a triangle area to cover up the hollow triangle area of the twin-tube frame to prevent a rider, particularly a young child, from getting hurt by accidentally stepping into the hollow triangle area.

### BACKGROUND OF THE INVENTION

(a) Field of the Invention

The present invention relates to a twin-tube frame scooter, and more particularly, to one that an inclined triangle area is provided to the front end of the board to cover up an inclined hollow triangle area of the twin-tube frame to prevent a young child rider from getting hurt by accidentally stepping into the hollow triangle area.

(b) Description of the Prior Art

A conventional scooter provides a single tube frame having at its front end pivoted with a handle, one tire each pivoted to both sides of the rear end of the frame, a board being disposed in the middle of the frame for a rider to stand upon it with one foot and to push against the ground with another foot to advance the scooter. As the scooter glides forward, the rider has both of his feet standing on the board. The rider uses one foot to push forward against the floor to decelerate then has both of feet back on the board to repeat the cycle for fun and for exercise. As illustrated in FIGS. 3 and 4 of the accompanying drawings, a scooter with a twin-tube frame has been made generally available in the market. The scooter is comprised of twin tubes (31, 32) with the front and the rear of each tube (31, 32) fixed with a fixation plate (33, 34) to form a horizontal tube frame (3A). Both tubes (31, 32) are incorporated to each other at their respective middle section in a direction inclined upward and a triangle area (3B) is defined as the front sections of both tubes (31, 32) extend upward to meet each other. However, a board (4) relates to merely a horizontal board covering upon the tube frame (3A) of the twin-tube frame (3) and secured with bolts (3B) (not illustrated). As a result, the triangle area (3B) becomes a trap to a rider, particularly a young child, would often accidentally step into it to get hurt, or bone fracture in serious cases.

### SUMMARY OF THE INVENTION

The primary purpose of the present invention is to provide a twin-tube frame scooter with improved riding safety, comprised of a twin-tube frame and a board. The twin-tube frame is comprised of two tubes connected to each other in parallel. The front and the rear of the tubes are each fixed with a fixation plate and an inclined triangle area is formed as both tubes extending forward and upward to meet each other. The middle portions of both tubes inclines upward and are incorporated to each other at their front ends with the board fixed onto the twin-tube frame, characterized by that a corresponding inclined triangle area is provided at the front section of the board to cover up the hollow triangle area of the twin-tube frame so to prevent accidental step into the hollow triangle are of the twin-tube by a rider, particularly a young child rider.

### BRIEF DESCRIPTION OF THE DRAWINGS

FIG. 1 is a side view of a preferred embodiment of the present invention.

FIG. 2 is a top view of the preferred embodiment of the present invention.

FIG. 3 is a side view of a prior art

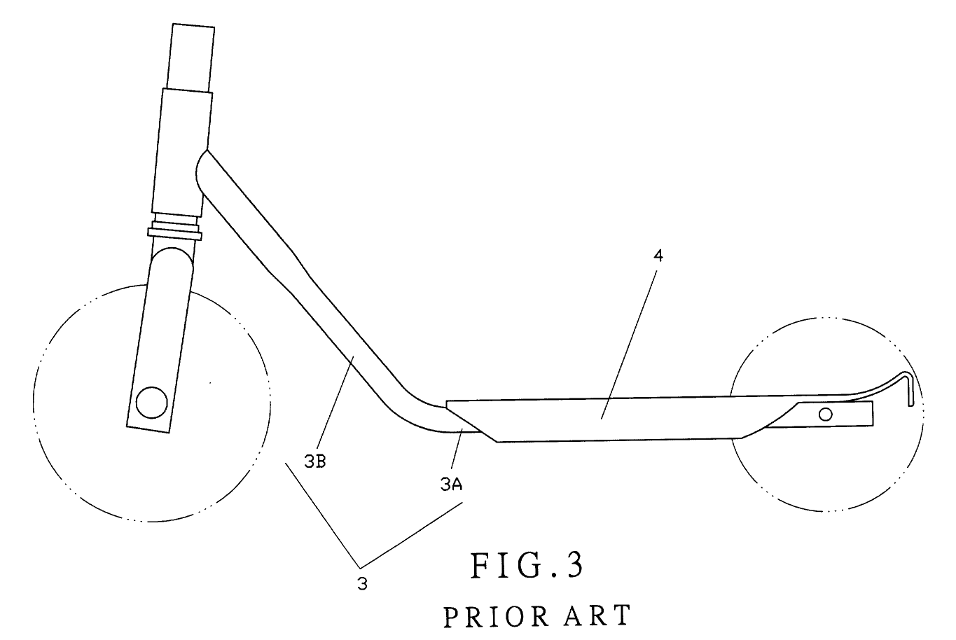

FIG. 4 is a top view of the prior art.

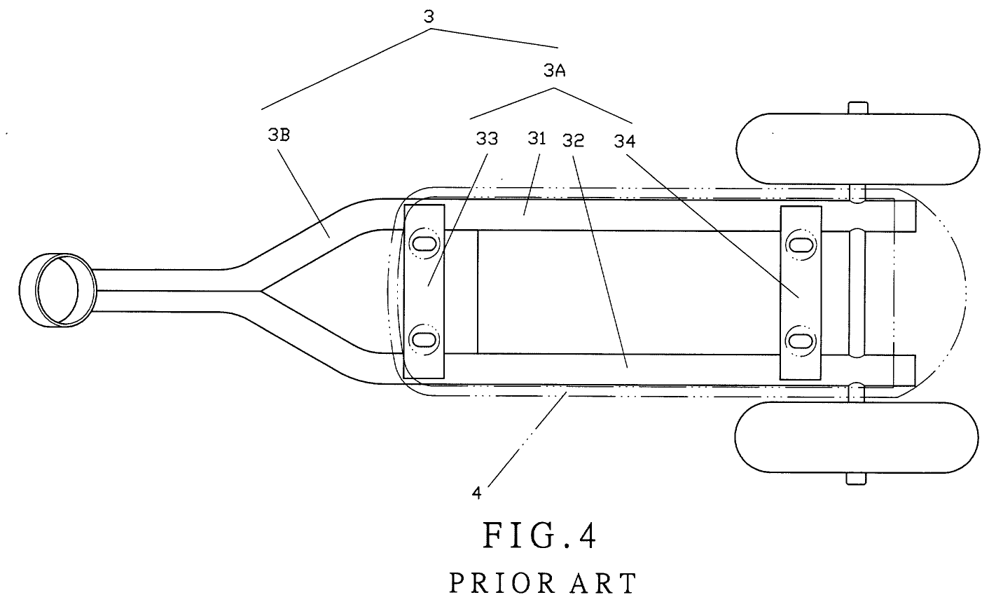

### DETAILED DESCRIPTION OF THE PREFERRED EMBODIMENTS

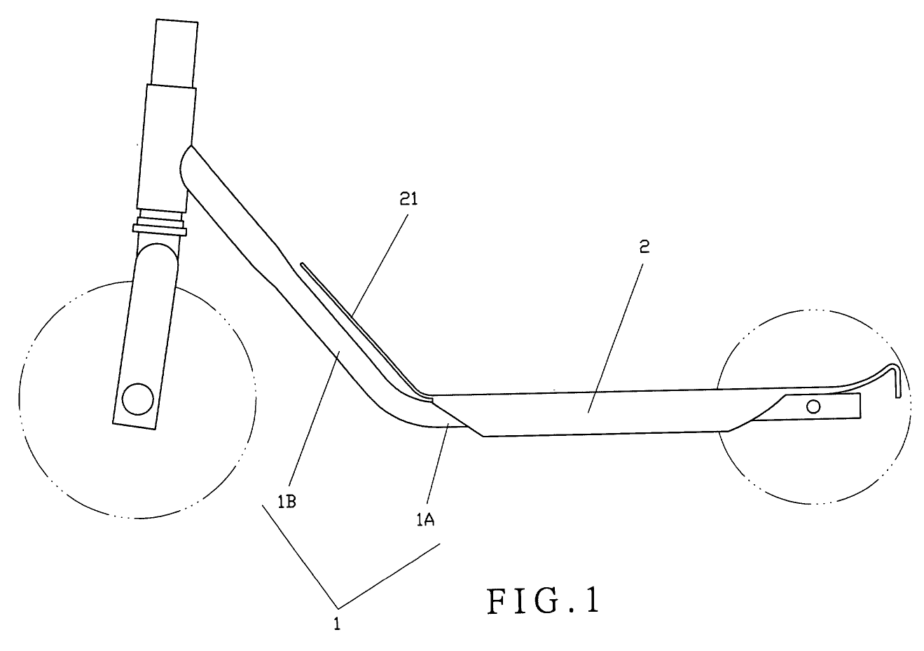

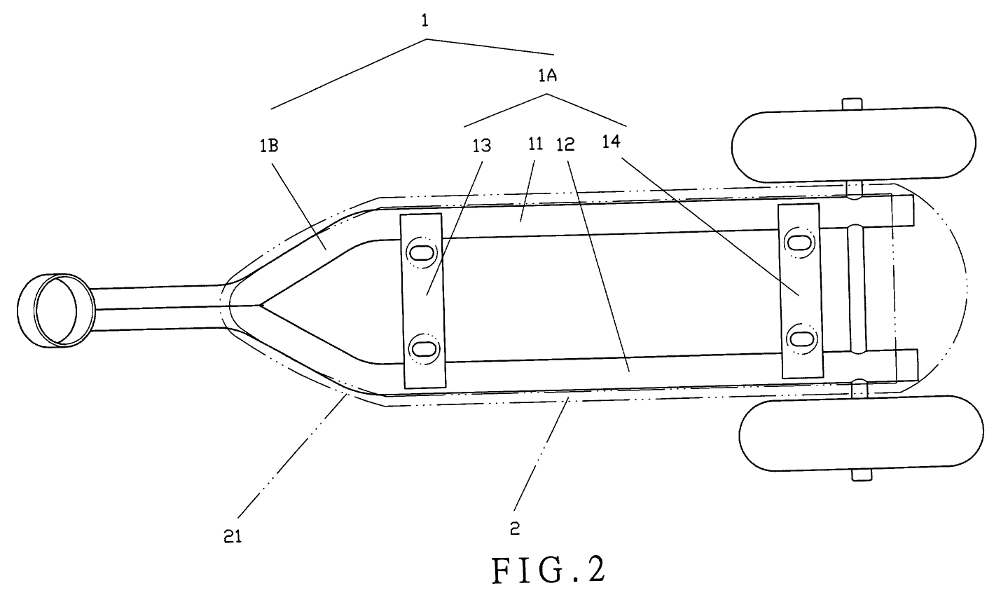

Referring to FIGS. 1 and 2, a preferred embodiment of the present invention is comprised of a twin-tube frame (1) and a board (2).

The twin-tube frame (1) includes two tubes (11, 12) connected to each other in parallel. The front and the rear of both tubes (11, 12) are each fixed with a fixation plate (13, 14) to form a horizontal tube frame (1A). Both of the tubes (11, 12) having at the respective middle section to incline upward and to incorporate to each other at their front sections while an inclined triangle area (1B) is defined as both of the tubes (11, 12) extend forward to meet each other.

The front section of the board (2) is provided with a corresponding inclined triangle area (21).

The board (2) is fixed with bolts (not illustrated) to the fixation plates (13, 14) of the twin-tube frame (1) to cover up the hollow triangle area (1B) of the front of the twin-tube frame (1). When a young child is riding on the board (2), he/she is prevented from stepping into the hollow triangle area (1B). The present invention offers more reliable riding since a rider is able to stand on the board against to the inclined triangle (21).

As disclosed, the present invention does offer improved riding safety by preventing the young child rider from accidentally stepping into the hollow triangle area.

I claim:

1. A twin-tube frame scooter comprising a twin-tube frame and a board; said twin-tube frame being formed horizontally with two tubes arranged in parallel having the front and the rear of said tubes fixed with each a fixation plate; the middle section of each tube being inclined upward and having the front section extending forward to meet each other; an inclined hollow triangle area being defined in the inclined front sections of said tubes; and said board being fixed onto said twin-tube frame, characterized by that
a corresponding triangle area is provided to the front section of said board to cover up said hollow triangle area of said twin-tube frame.
